(19) United States
(12) Patent Application Publication
(10) Pub. No.: US 2024/0381866 A1
(43) Pub. Date: Nov. 21, 2024

(54) Camouflage Blind Device

(71) Applicants: Ceth Carnley, Pagosa Springs, CO (US); Ashley Carnley, Pagosa Springs, CO (US)

(72) Inventors: Ceth Carnley, Pagosa Springs, CO (US); Ashley Carnley, Pagosa Springs, CO (US)

(21) Appl. No.: 18/354,813

(22) Filed: Jul. 19, 2023

Related U.S. Application Data
(60) Provisional application No. 63/502,253, filed on May 15, 2023.

(51) Int. Cl. A01M 31/02; F41A 23/14

(52) U.S. Cl. CPC A01M 31/025; F41A 23/14

(57) ABSTRACT

A camouflage blind device is provided. The device is comprised of a frame with at least one camouflage member that camouflages the frame and at least one folding camouflage member that can be extended from the frame to further camouflage the area around the device. An attachment member of the device can receive a camera or a firearm support attachment which can receive a firearm to act as a shooting rest.

### CROSS-REFERENCE TO RELATED APPLICATION

The present application claims priority to, and the benefit of, U.S. Provisional Application No. 63/502,253, which was filed on May 15, 2023, and is incorporated herein by reference in its entirety.

### FIELD OF THE INVENTION

The present invention relates generally to the field of concealment devices. More specifically, the present invention relates to a camouflage blind device that conceals a user behind the device while hunting or photographing. In addition, the device also supports a firearm or camera. Accordingly, the present disclosure makes specific reference thereto. Nonetheless, it is to be appreciated that aspects of the present invention are also equally applicable to other like applications, devices, and methods of manufacture.

### BACKGROUND

While hunting and photographing wildlife, it is important for a hunter or photographer to remain hidden and camouflaged to prevent frightening animals. A hunter or photographer may need to reposition themselves for a better view or shot and end up scaring away wildlife due to their lack of concealment. As a result, without proper concealment hunters and photographers may lose out on the perfect shot.

Therefore, there exists a long-felt need in the art for a device that offers concealment for hunters and photographers alike. There also exists a long-felt need in the art for a camouflage blind device. More specifically, there exists a long-felt need in the art for a camouflage blind device that offers concealment to a photographer or a hunter. In addition, there exists a long-felt need in the art for a camouflage blind device that offers concealment to a photographer or a hunter and wherein the device also supports a camera or a firearm.

The subject matter disclosed and claimed herein, in one embodiment thereof, comprises a camouflage blind device. The device is comprised of a frame with at least one camouflage member that camouflages the frame and at least one folding camouflage member that can be extended from the frame to further camouflage the area around the device. An attachment member of the device can receive a camera or a firearm support attachment which can receive a firearm to act as a shooting rest.

In this manner, the camouflage blind device of the present invention accomplishes all the foregoing objectives and provides a device that offers concealment for hunters and photographers alike. More specifically, the device offers concealment to a photographer or a hunter. While doing so, the device also supports a camera or a firearm.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a camouflage blind device designed to camouflage a user while standing behind the device, and wherein the device is used to support a camera or a firearm while hunting/photographing. The device is primarily comprised of a frame with at least one opening, wherein at least one central shaft can be raised/lowered through the opening to increase or decrease the height of the device as needed during use. The shaft may be locked at a desired height through the opening via at least one locking member.

The frame is further comprised of at least one leg. The device may have one leg (monopod) or three legs (tripod). Each leg may be of a fixed length or may be telescopic to allow a user to further adjust the height of the device. In a tripod embodiment, at least one camouflage member is fixedly or removably attached between each leg. The member serves to camouflage a user standing behind the device. To further conceal a user behind the device, the device may be comprised of at least one folding camouflage member that attaches to the frame via at least one pivot point, such as, but not limited to, a locking hinge. The member serves to further camouflage a user standing behind the device by increasing the area the device covers. The member may be made of fabric or other material, wherein the member has any camouflage pattern and/or color known in the art.

The central shaft further receives at least one attachment member. More specifically, the bottom surface of the attachment member is comprised of at least one fastener that engages at least one fastener of the central shaft. Similarly, the top surface of the attachment member is comprised of at least one fastener that preferably engages a fastener of a camera to allow the camera to attach to the device.

In an embodiment wherein the device is intended to support a firearm instead of a camera, the attachment member receives at least one firearm support attachment. Said attachment attaches to the fastener of the top surface of the attachment member via at least one fastener. The support attachment is comprised of at least one support structure that receives some portion of a firearm. The structure may be generally U-shaped or may be any other firearm receiving structure and shape known in the art.

The present invention is also comprised of a method of using the device. First, a device is provided comprised of at least one leg, a central shaft, at least one folding camouflage member, and an attachment member. Then, a user can unfold the folding camouflage member and lock the member into a desired position via the locking mechanism. Next, the central shaft can be raised/lowered through the opening of the frame and secured in said desired position via the locking member. Then, an attachment member can be attached to the central shaft via attaching the fastener of the member to the fastener of the shaft. Next, a camera can be attached to the fastener of the attachment member via a fastener of the camera, wherein the camera is supported by the device and can be used while the camouflage member conceals a user standing behind the member and device.

Another method of using the device involves providing a device comprised of at least one leg, a central shaft, at least one folding camouflage member, and an attachment member. Then, a user can unfold the folding camouflage member and lock the member into a desired position via the locking mechanism. Next, the central shaft can be raised/lowered through the opening of the frame and secured in said desired position via the locking member. Then, an attachment member can be attached to the central shaft via attaching the fastener of the member to the fastener of the shaft. Next, a firearm support attachment can be attached to the fastener of the attachment member via a fastener of the attachment, wherein a firearm is supported by the support structure of the attachment and the device and can be used while the camouflage member conceals a user standing behind the member and device.

Accordingly, the camouflage blind device of the present invention is particularly advantageous as it provides a device that offers concealment for hunters and photographers alike. More specifically, the device offers concealment to a photographer or a hunter. While doing so, the device also supports a camera or a firearm. In this manner, the camouflage blind device provides a solution for hunters and photographers alike to remain concealed while hunting or photographing.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a camouflage blind device of the present invention in accordance with the disclosed architecture;

FIG. 2 illustrates an enhanced, partially exploded perspective view of one potential embodiment of a camouflage blind device of the present invention in accordance with the disclosed architecture;

FIG. 3 illustrates a perspective view of one potential embodiment of a camouflage blind device of the present invention while supporting a firearm in accordance with the disclosed architecture;

FIG. 4 illustrates a perspective view of one potential embodiment of a camouflage blind device of the present invention while supporting a camera in accordance with the disclosed architecture;

FIG. 5 illustrates a flowchart of a method of using one potential embodiment of a camouflage blind device of the present invention in accordance with the disclosed architecture; and

FIG. 6 illustrates a flowchart of a method of using one potential embodiment of a camouflage blind device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that offers concealment for hunters and photographers alike. There also exists a long-felt need in the art for a camouflage blind device. More specifically, there exists a long-felt need in the art for a camouflage blind device that offers concealment to a photographer or a hunter. In addition, there exists a long-felt need in the art for a camouflage blind device that offers concealment to a photographer or a hunter and wherein the device also supports a camera or a firearm.

The present invention, in one exemplary embodiment, is comprised of a camouflage blind device. The device is designed to camouflage a user while standing behind the device. While doing so, the device is also used to support a camera or a firearm while hunting/photographing. The device is primarily comprised of a frame with at least one opening, wherein at least one central shaft can be raised/lowered through the opening to increase or decrease the height of the device as needed during use. The shaft may be locked at a desired height through the opening via at least one locking member.

The frame is further comprised of at least one leg. The device may have one leg (monopod) or three legs (tripod). Each leg may be of a fixed length or may be telescopic to allow a user to further adjust the height of the device. In a tripod embodiment, at least one camouflage member is fixedly or removably attached between each leg. The member serves to camouflage a user standing behind the device.

To further conceal a user behind the device, the device may be comprised of at least one folding camouflage member. The member attaches to the frame via at least one pivot point, such as, but not limited to, a locking hinge. The member serves to further camouflage a user standing behind the device by increasing the area the device covers. The member may be made of a fabric or other material, wherein the member has any camouflage pattern and/or color known in the art.

The central shaft further receives at least one attachment member. More specifically, the bottom surface of the attachment member is comprised of at least one fastener that engages at least one fastener of the central shaft. Similarly, the top surface of the attachment member is comprised of at least one fastener that preferably engages a fastener of a camera to allow the camera to attach to the device.

In an embodiment wherein the device is intended to support a firearm instead of a camera, the attachment member receives at least one firearm support attachment. Said attachment attaches to the fastener of the top surface of the attachment member via at least one fastener. The support attachment is comprised of at least one support structure that receives some portion of a firearm. The structure may be generally U-shaped or may be any other firearm receiving structure and shape known in the art.

The present invention is also comprised of a method of using the device. First, a device is provided comprised of at least one leg, a central shaft, at least one folding camouflage member, and an attachment member. Then, a user can unfold the folding camouflage member and lock the member into a desired position via the locking mechanism. Next, the central shaft can be raised/lowered through the opening of the frame and secured in said desired position via the locking member. Then, an attachment member can be attached to the central shaft via attaching the fastener of the member to the fastener of the shaft. Next, a camera can be attached to the fastener of the attachment member via a fastener of the camera, wherein the camera is supported by the device and can be used while the camouflage member conceals a user standing behind the member and device.

Another method of using the device involves providing a device comprised of at least one leg, a central shaft, at least one folding camouflage member, and an attachment member. Then, a user can unfold the folding camouflage member and lock the member into a desired position via the locking mechanism. Next, the central shaft can be raised/lowered through the opening of the frame and secured in said desired position via the locking member. Then, an attachment member can be attached to the central shaft via attaching the fastener of the member to the fastener of the shaft. Next, a firearm support attachment can be attached to the fastener of the attachment member via a fastener of the attachment, wherein a firearm is supported by the support structure of the attachment and the device and can be used while the camouflage member conceals a user standing behind the member and device.

Accordingly, the camouflage blind device of the present invention is particularly advantageous as it provides a device that offers concealment for hunters and photographers alike. More specifically, the device offers concealment to a photographer or a hunter. While doing so, the device also supports a camera or a firearm. In this manner, the camouflage blind device provides a solution for hunters and photographers alike to remain concealed while hunting or photographing.

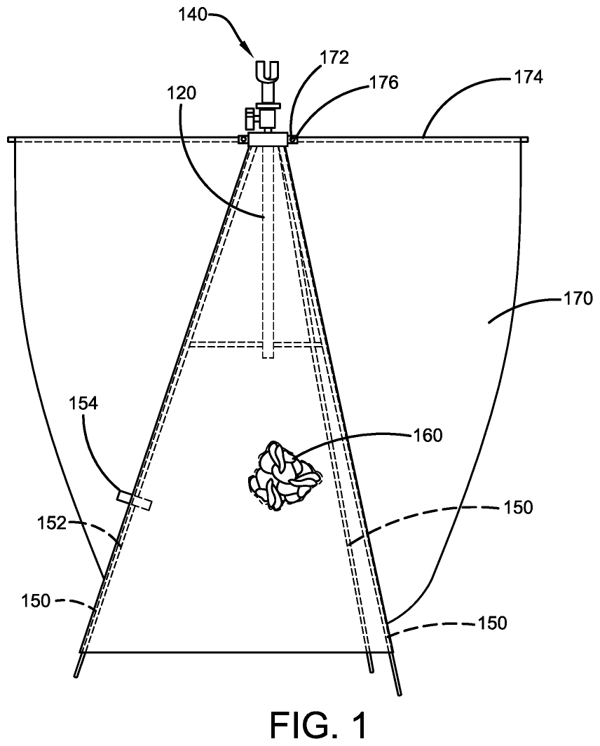

Referring initially to the drawings, FIG. 1 illustrates a perspective view of one potential embodiment of a camouflage blind device 100 of the present invention in accordance with the disclosed architecture. The device 100 is designed to camouflage a user 10 while standing behind the device 100, and wherein the device 100 is used to support a camera 20 or a firearm 30 while hunting/photographing. The device 100 is primarily comprised of a frame 110. The frame 110 has at least one opening 112, wherein at least one central shaft 120 can be raised/lowered through the opening 112 to increase or decrease the height of the device 100 as needed during use. The shaft 120 may be locked at a desired height through the opening 112 via at least one locking member 122 such as, but not limited to, a threaded knob, a button, a clip, a clamp, etc.

The frame 110 is further comprised of at least one leg 150. The device 100 may have one leg 150 (monopod) or three folding legs 150 (tripod). Each leg 150 may be of a fixed length or may be telescopic to allow a user to further adjust the height of the device 100 and level the device 100 on uneven terrain. More specifically, the leg 150 may be comprised of a telescoping member 152 that can be extended or retracted into the leg 150 and secured at said position via at least one locking member 154. The locking member 154 may be any type known in the art such as, but not limited to, a clip, a clamp, a threaded knob, a button, etc.

In a tripod embodiment, at least one camouflage member 160 is fixedly or removably attached between each leg 150. The member 160 serves to camouflage a user 10 standing behind the device 100. The member 160 may be made of a fabric or other material (such as, but not limited to, a corrugated material), wherein the member 160 has any camouflage pattern and/or color known in the art.

To further conceal a user 10 behind the device 100, the device 100 may be comprised of at least one folding camouflage member 170. The member 170 attaches to the frame 110 via at least one pivot point 172, such as, but not limited to, a locking hinge. The member 170 is preferably made of a corrugated material to allow the member 170 to fold easily when not extended during use.

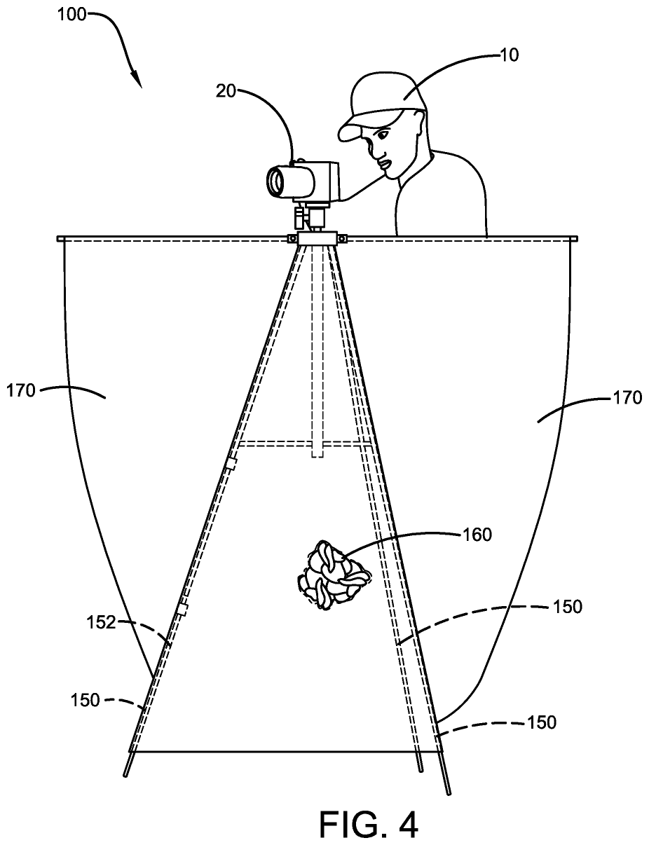

The member 170 serves to further camouflage a user 10 standing behind the device 100 by increasing the area the device 100 covers, as seen in FIG. 4. The member 170 may be made of fabric or other material, wherein the member 170 has any camouflage pattern and/or color known in the art. The member 170 may be supported by at least one frame member 174 that provides structural support when the member 170 is extended. The member 170 may be locked into an extended position via at least one locking mechanism 176 connected to the pivot point 172 such as, but not limited to, a button, a clip, a clamp, etc. The member 170 may also removably or fixedly attach to any leg 150 of the device 100.

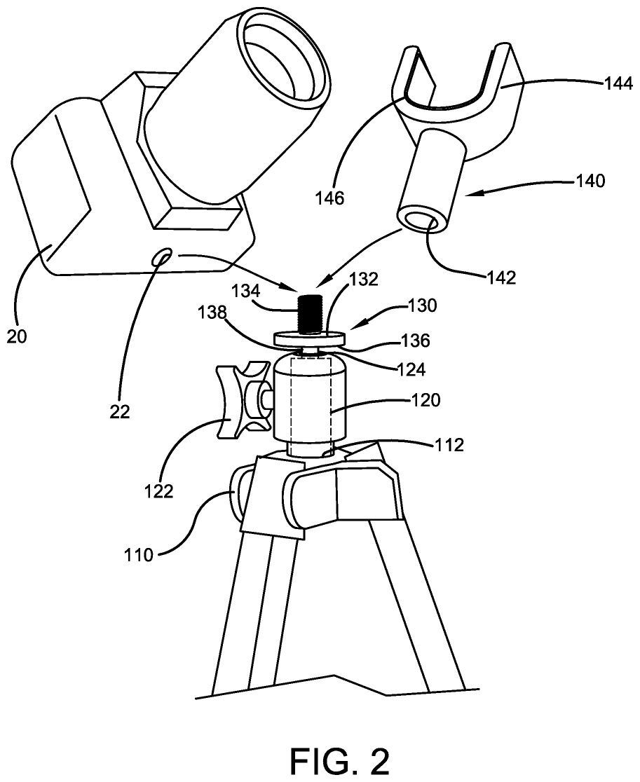

The central shaft 120 further receives at least one attachment member 130, as seen in FIG. 2. More specifically, a bottom surface 136 of the attachment member 130 is comprised of at least one fastener 138 that engages at least one fastener 124 of the central shaft 120. The fasteners 124,138 are preferably threaded fasteners but may be any type of reciprocating fastener known in the art. In one embodiment, the fastener 124 of the shaft 120 is comprised of a socket joint, and the fastener 138 of the attachment member 130 is comprised of a ball joint, thus allowing the attachment member 130 to be rotated 360 degrees vertically relative to the central shaft 120 and 90 degrees horizontally (in any direction) relative to the shaft). This allows a camera 20 or firearm 30 to be easily tilted/repositioned during use.

Similarly, the top surface 132 of the attachment member 130 is comprised of at least one fastener 134. The fastener 134 preferably engages a fastener 22 of a camera 20 to allow the camera 20 to attach to the device 100. The fasteners 22,134 may be any type of reciprocating fasteners known in the art but are preferably threaded fasteners.

In an embodiment wherein the device 100 is intended to support a firearm 30 instead of a camera 20, the attachment member 130 receives at least one firearm support attachment 140. Said attachment 140 attaches to the fastener 134 of the top surface 132 of the attachment member 130 via at least one fastener 142. The fasteners 134,142 may be any reciprocating fastener type known in the art but are preferably reciprocating threads.

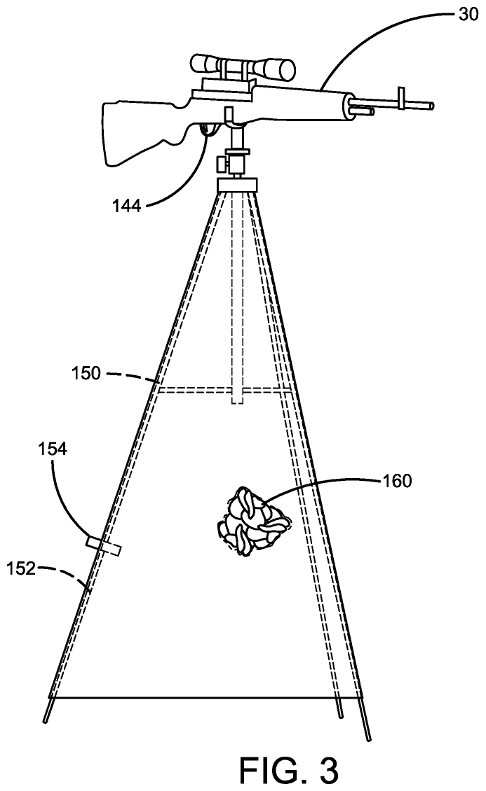

The support attachment 140 is comprised of at least one support structure 144 that receives some portion of a firearm 30, as seen in FIG. 3. The structure 144 may be generally U-shaped, or may be any other firearm 30 receiving structure and shape known in the art such as, but not limited to, a clip, a clamp, etc. The support structure 144 may also be comprised of a padding 146 to protect the firearm 30 against scratches/damages from the structure 144 during use.

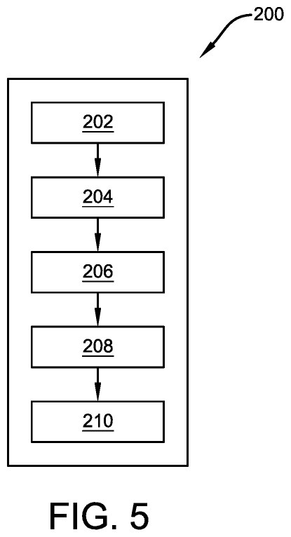

The present invention is also comprised of a method of using 200 the device 100, as seen in FIG. 5. First, a device 100 is provided comprised of at least one leg 150, a central shaft 120, at least one folding camouflage member 170, and an attachment member 130 [Step 200]. Then, a user can unfold the folding camouflage member 170 (preferably such that it is perpendicular to the central shaft 120) and lock the member 170 into a desired position via the locking mechanism 176 [Step 202]. In an embodiment, wherein the leg 150 is telescopic, the telescoping member 152 of the leg can be extended or retracted from the leg 150 and locked into said position via the locking member 154 [Step 204]. Next, the central shaft 120 can be raised/lowered through the opening 112 of the frame 110 and secured in said desired position via the locking member 122 [Step 206]. Then, an attachment member 130 can be attached to the central shaft 120 via attaching the fastener 138 of the member 130 to the fastener 124 of the shaft [Step 208]. Next, a camera 20 can be attached to the fastener 134 of the attachment member 130 via a fastener 22 of the camera 20, wherein the camera 20 is supported by the device 100 and can be used while the camouflage member 170 conceals a user 10 standing behind the member 170 and device 100 [Step 210].

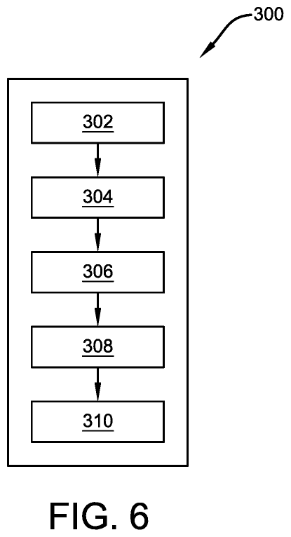

The present invention is also comprised of a second method of using 300 the device 100, as seen in FIG. 6. First, a device 100 is provided comprised of at least one leg 150, a central shaft 120, at least one folding camouflage member 170, and an attachment member 130 [Step 300]. Then, a user can unfold the folding camouflage member 170 (preferably such that it is perpendicular to the central shaft 120) and lock the member 170 into a desired position via the locking mechanism 176 [Step 302]. In an embodiment, wherein the leg 150 is telescopic, the telescoping member 152 of the leg can be extended or retracted from the leg 150 and locked into said position via the locking member 154 [Step 304]. Next, the central shaft 120 can be raised/lowered through the opening 112 of the frame 110 and secured in said desired position via the locking member 122 [Step 306]. Then, an attachment member 130 can be attached to the central shaft 120 via attaching the fastener 138 of the member 130 to the fastener 124 of the shaft [Step 308]. Next, a firearm support attachment 140 can be attached to the fastener 134 of the attachment member 130 via a fastener 142 of the attachment 140, wherein a firearm 30 is supported by the support structure 144 of the attachment 140 and the device 100 and can be used while the camouflage member 170 conceals a user 10 standing behind the member 170 and device 100 [Step 310].

Certain terms are used throughout the following description and claims to refer to particular features or components. As one skilled in the art will appreciate, different persons, may refer to the same feature or component by different names. This document does not intend to distinguish between components or features that differ in name but not structure or function. As used herein “camouflage blind device” and “device” are interchangeable and refer to the camouflage blind device 100 of the present invention.

Notwithstanding the foregoing, the camouflage blind device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the camouflage blind device 100 as shown in the FIGS. are for illustrative purposes only, and that many other sizes and shapes of the camouflage blind device 100 are well within the scope of the present disclosure. Although the dimensions of the camouflage blind device 100 are important design parameters for user convenience, the camouflage blind device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A camouflage blind device comprising:
a frame comprised of an opening and a leg;
an attachment member comprised of a top surface comprised of a first fastener, and a bottom surface comprised of a second fastener;
a central shaft comprised of a third fastener;
a locking member; and
a folding camouflage member attached to the frame via a pivot point.

2. A camouflage blind device of claim 1, wherein the folding camouflage member is comprised of a corrugated material.

3. A camouflage blind device of claim 1, wherein the central shaft is comprised of a locking member.

4. A camouflage blind device of claim 1, wherein the first fastener is comprised of a thread.

5. A camouflage blind device of claim 1, wherein the central shaft is positioned within the opening.

6. A camouflage blind device comprising:
a frame comprised of an opening, a first leg, a second leg, and a third leg;
an attachment member comprised of a top surface comprised of a first fastener, and a bottom surface comprised of a second fastener;
a camouflage member;
a central shaft comprised of a third fastener; and
a folding camouflage member attached to the frame via a pivot point; and
a firearm support attachment comprised of a further fastener and a support structure.

7. A camouflage blind device of claim 6, wherein the first leg, the second leg, and the third leg are comprised of telescopic legs.

8. A camouflage blind device of claim 7, wherein the first leg, the second leg, and the third leg are each comprised of a locking member.

9. A camouflage blind device of claim 6, wherein the support structure is generally U-shaped.

10. A camouflage blind device of claim 6, wherein the support structure is comprised of a padding.

11. A camouflage blind device of claim 6, wherein the second fastener and the third fastener are comprised of reciprocating threads.

12. A camouflage blind device of claim 6, wherein the second fastener and the third fastener are comprised of a ball and socket joint.

13. A camouflage blind device of claim 6, wherein the camouflage member attaches to the first leg and the second leg, to the first leg and the third leg, or to the second leg and the third leg.

14. A camouflage blind device of claim 6, wherein the support structure is comprised of a clip or a clamp.

15. A camouflage blind device of claim 6, wherein the first leg, the second leg, and the third leg are comprised of folding legs.

16. A camouflage blind device of claim 6, wherein the camouflage member is comprised of a camouflage pattern.

17. A camouflage blind device of claim 6, wherein the pivot point is comprised of a locking member.

18. A method of using a camouflage blind device, the method comprising:
providing a camouflage blind device comprised of comprised of a leg, a central shaft, a folding camouflage member, and an attachment member;
unfolding the camouflage member and locking the camouflage member into a desired position via a first locking mechanism;
raising or lowering the central shaft through an opening of a frame of the camouflage blind device and locking the central shaft at a desired position via a second locking mechanism; and
attaching an attachment member to the central shaft.

19. A camouflage blind device of claim 18 comprised of attaching a camera to the attachment member.

20. A camouflage blind device of claim 18 comprised of attaching a firearm support attachment to the attachment member and placing a firearm into a support structure of the firearm support member.
